(19) United States
(12) Patent Application Publication
(10) Pub. No.: US 2023/0188341 A1
(43) Pub. Date: Jun. 15, 2023

(54) CRYPTOGRAPHIC OPERATIONS IN EDGE COMPUTING NETWORKS

(71) Applicant: Intel Corporation, Santa Clara, CA (US)

(72) Inventors: Ruoyu Ying, Shanghai (CN); Ruijing Guo, Shanghai (CN); Shaojun Ding, Redmond, WA (US); Qiang Ren, Shanghai (CN); Haibin Huang, Shanghai (CN); Jie Ren, Shanghai (CN)

(21) Appl. No.: 18/106,259

(22) Filed: Feb. 6, 2023

(30) Foreign Application Priority Data
Dec. 16, 2022 (WO) PCT/CN2020/139605

(51) Int. Cl. H04L 9/08; G06F 21/53

(52) U.S. Cl. CPC H04L 9/0897; G06F 21/53

(57) ABSTRACT

An apparatus can include an interface coupled to processing circuitry and cryptographic circuitry coupled to the interface. The cryptographic circuitry can receive a request from the processing circuitry over the interface to perform a cryptographic operation using a remote hardware security module (HSM) key component. The cryptographic circuitry can further transmit a command to a remote component to retrieve the remote HSM key component. Subsequent to receiving the cryptographic key component, the cryptographic circuitry can construct a trusted execution environment (TEE) instance and store the remote HSM key component in the TEE instance. The cryptographic circuitry can use the remote HSM key component to perform the cryptographic operation and provide a result of the cryptographic operation to the processing circuitry over the interface.

This application claims the benefit of priority to International Application No. PCT/CN2022/139605, filed Dec. 16, 2022, which is incorporated herein by reference in its entirety.

### BACKGROUND

At a general level, edge computing refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network. Security has increasingly become a concern in edge computing systems and on-premises systems.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 provides a detailed overview of example components within a computing device in an Edge computing system.

FIG. 5 illustrates an architecture of a distributed cryptographic agent and universal hardware security module based on a trusted executed environment according to some example embodiments.

FIG. 6 illustrates signal and messaging flow between components of a system according to some example embodiments.

FIG. 7 is a flowchart of a method according to some example embodiments.

### DETAILED DESCRIPTION

Security has become a concern in all aspects of computer technology, wherever in software, hardware, networking, or other areas and aspects.

Cryptography can address security concerns to ensure the confidentiality, integrity, and availability of critical assets.

Cryptography and other security solutions can become complicated for applications running on the edge or on-premises. In the case of the edge computing scenarios, applications typically have stringent low latency requirements while also having limited bandwidth. However, acquiring security measures at edge computing hardware usually adds to latency and consumes bandwidth. Furthermore, unstable network access may cause issues in the above-described security solutions or other security solutions, resulting in poor user experience.

Hardware security modules (HSM) can be used to protect cryptographic keys, but these also can add to latency and consume bandwidth. In addition, flexibility can be a concern with HSMs. Keys can be stored using various HSMs provided by multiple different vendors or cryptographic service providers. Some HSMs can include those provided by Thales of Paris, France or Entrust of Minneapolis, Minn.; Azure Key Vault available from Microsoft® of Seattle, Wash.; Amazon Web Services (AWS) Key Management Service available from Amazon of Seattle, Wash.; and services provided by HashiCorp Vault of San Francisco, Calif., etc. This can increase the complexity for user applications that must switch between these different HSMs and providers, at least because there does not currently exist a unified application programming interface (API) for accessing this hardware.

To address these concerns, some available systems can offer HSM services in the cloud. Other solutions can include providing a hardware Trusted Execution Environment (TEE), which can provide a secure area in processing circuitry to serve as a substitute for HSM. Private regions of memory can be allocated within TEEs, referred to hereinafter as “security enclaves” or merely “enclaves.” Some example hardware TEEs can include Data Security Manager (DSM), available through Fortanix® of Mountain View, Calif. DSM can use a hardware TEE as a backend and a HSM Gateway to connect to cloud-based HSMs. An additional example is provided by the eHSM project available on GitHub, Inc. of San Francisco, Calif., which uses a hardware TEE to implement the related APIs and act as an HSM. Both solutions require that the cryptographic operations occur in the cloud rather than the edge. Therefore, these solutions still exhibit latency and bandwidth concerns due to the time and bandwidth needed to provide keys to the edge. These solutions also still involve significant network overhead and potential connection issues for edge applications to connect to the cloud or far edge for key operations. Finally, some users may prefer HSM for perceived higher security relative to hardware TEEs. For example, some users may prefer that keys be persistently stored in an HSM. For at least these reasons, a unified API may be preferred to access multiple different HSMs provided by multiple different vendors.

Systems and methods according to some embodiments address these and other concerns by implementing a distributed architecture to provide HSM-level protection while retaining high performance in edge and on-premises scenarios. A hardware TEE is utilized to construct an ephemeral but safe area on the edge or on-premises to hold cryptographic keys and handle cryptographic-related operations while the keys are in use. Keys can be destroyed after runtime usage. In addition, components are introduced in the cloud or far edge to provide a uniform, more-accessible API to connect with multiple vendor HSMs or CSP cloud-based HSMs. This component can also be used to migrate sensitive keys between vendor-specific HSMs. A distributed cryptographic agent can be provided to enhance availability of customization and ensure low latency and low storage needs for systems and apparatuses according to some example embodiments.

### Implementing Systems and Environments

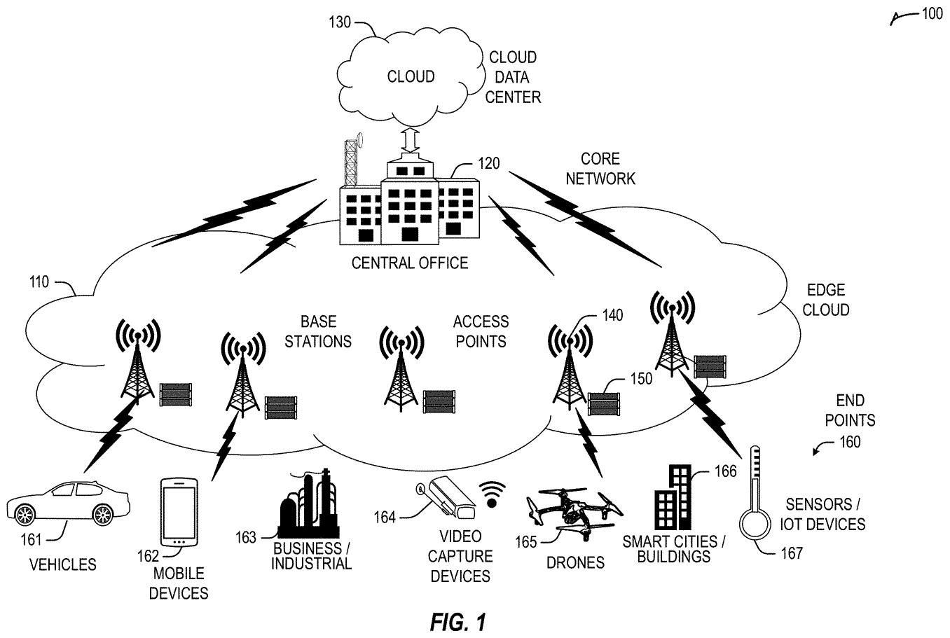

FIG. 1 is a block diagram 100 showing an overview of a configuration for Edge computing, which includes a layer of processing referred to in many of the following examples as an “Edge cloud”. As shown, the Edge cloud 100 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge,” “close Edge,” “local Edge,” “middle Edge,” or “far Edge” layers, depending on latency, distance, and timing characteristics.

Edge computing is a developing paradigm where computing is performed at or closer to the “Edge” of a network, typically through the use of a compute platform (e.g., ×86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

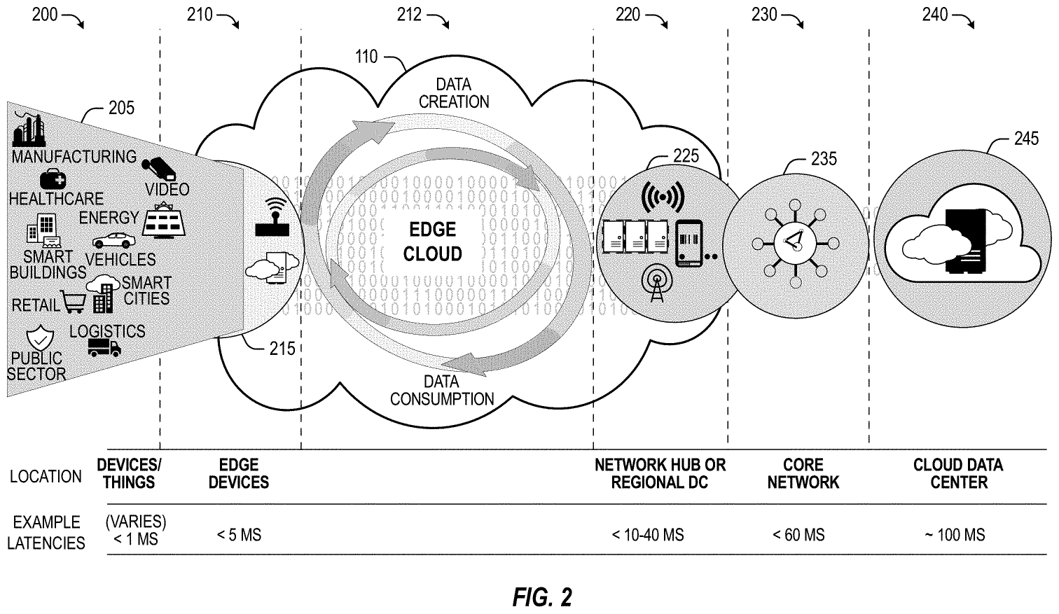

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premises servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge,” “local Edge,” “near Edge,” “middle Edge,” or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premises server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). A server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

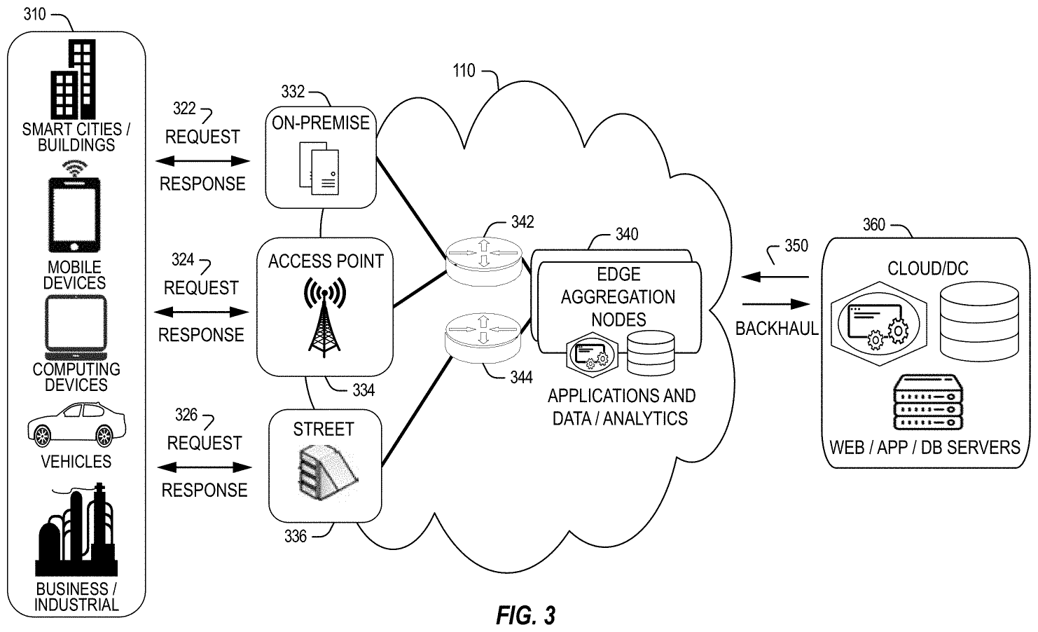

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premises network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

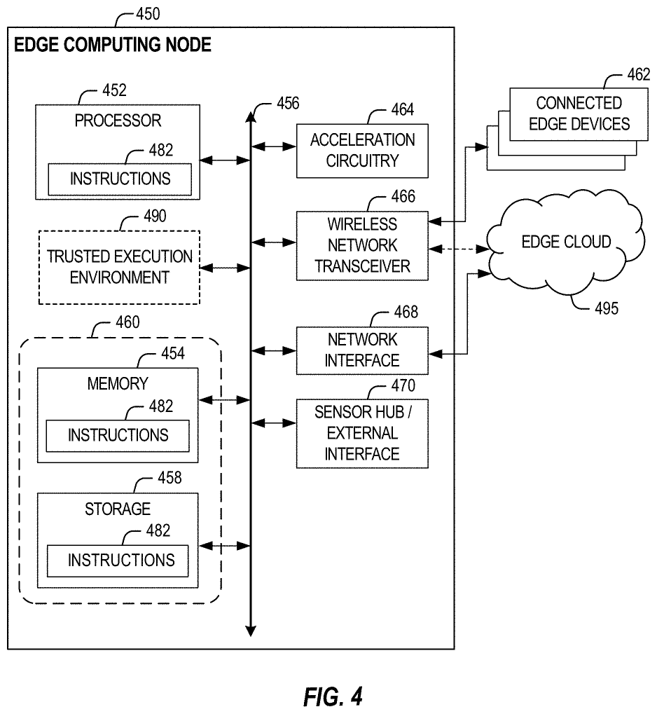

FIG. 4 provides a detailed overview of example components within a computing device in an Edge computing system. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

This Edge computing node 450 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 450, or as components otherwise incorporated within a chassis of a larger system.

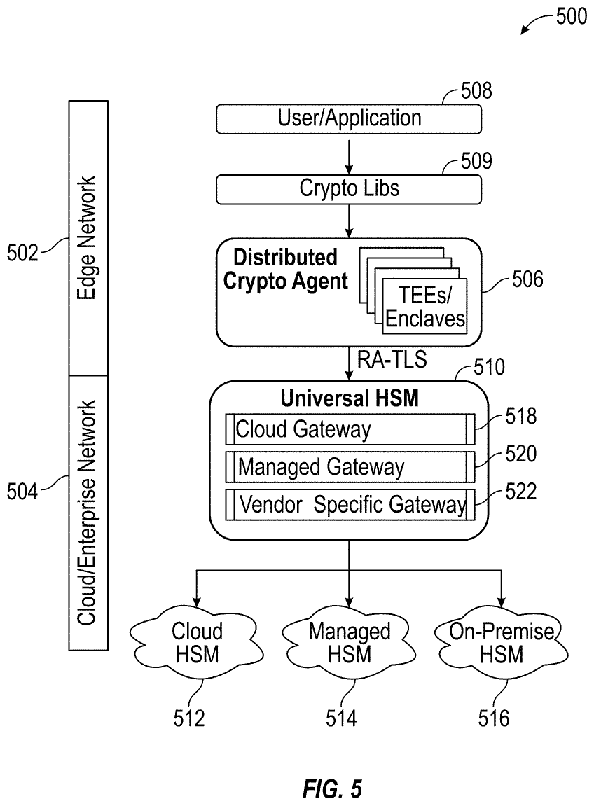

The instructions 482 on the processor 452 (separately, or in combination with the instructions 482 of the machine readable medium 460) may configure execution or operation of a trusted execution environment (TEE) 490. In an example, the TEE 490 operates as a protected area accessible to the processor 452 for secure execution of instructions and secure access to data. Various implementations of the TEE 490, and an accompanying secure area in the processor 452 or the memory 454 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 450 through the TEE 490 and the processor 452. Further details regarding TEE 490 and implementations of embodiments using TEE 490 or similar components are described in more detail below with reference to FIGS. 5-7.

### Distributed Cryptographic Agent and Universal Hardware Security Module

FIG. 5 illustrates an architecture 500 of a cryptographic agent (e.g., components of cryptographic circuitry, which can operate in a distributed fashion across multiple sites, computing systems, etc.) and universal hardware security module (HSM) based on a trusted executed environment (e.g., TEE 490 (FIG. 4)) according to some example embodiments. Embodiments further provide a unified interface to multiple kinds of HSMs. Some elements of the architecture 500 can be executed with an edge network 502, which can be similar to e.g., edge cloud 110 (FIG. 1) or on-premises. Other components of the architecture can be executed within a cloud or enterprise network 504 similar to, e.g., cloud 130 (FIG. 1).

For example, cryptographic circuitry 506 can execute within the edge network 502, or on-premises close to the point at which the user application 508 may be executing or running. The user application 508 can provide data to libraries 509 executing, for example, OpenSSL although embodiments are not limited thereto. The output of libraries 509 can include cryptographic application programming interface (API) calls that can be based on or use, for example, Public-Key Cryptography Standards (PKCS), REST embedding technology, Key Management Interoperability Protocol (KMIP), Java Cryptography Extension (JCE), Cryptography Next Generation (CNG), etc., although embodiments are not limited thereto. The distributed cryptographic agent 506 can utilize an ephemeral TEE instance to cache cryptographic keys fetched from an external HSM 510. Cryptographic operations can be performed securely within a local TEE instance to improve performance. In some example embodiments, when cryptographic operations are completed, the local TEE instance can be removed to prevent potential key exposure.

The universal HSM 510 can be executed within the cloud 504 or “far edge” (wherein “far edge” was described earlier herein). The universal HSM can act as a gateway by providing a unified API that can operate to connect with various HSMs (including cloud HSM 512, managed HSM 514, or on-premises HSM 516) of various vendors or CSPs. Accordingly, the universal HSM 510 can provide a gateway for porting cryptographic keys from remote HSMs (e.g., cloud HSM 512, managed HSM 514, or on-premises HSM 516) and providing the keys to the distributed cryptographic agent 506. Also, using the universal HSM gateways 518, 520, 522, users can manage HSMs from different vendors through a unified API. In some example embodiments, key migration between HSMs can be supported using the universal HSM 510. To ensure the security of the imported keys, attestation is invoked as a heartbeat operation between the cryptographic circuitry 506 and the universal HSM, which can reduce time needed to import keys.

In the context of various embodiments, a heartbeat operation can be defined as a period signal generated by the universal HSM to indicate that the distribute cryptographic agent is a trustworthy environment in which to cache keys. In example systems, attestation is needed right before one attempt to transport credentials into the hardware TEEs. A periodic check can simplify this procedure by checking if there is a valid attestation session. If there is a valid session, the attestation can be skipped for that cycle or at that moment.

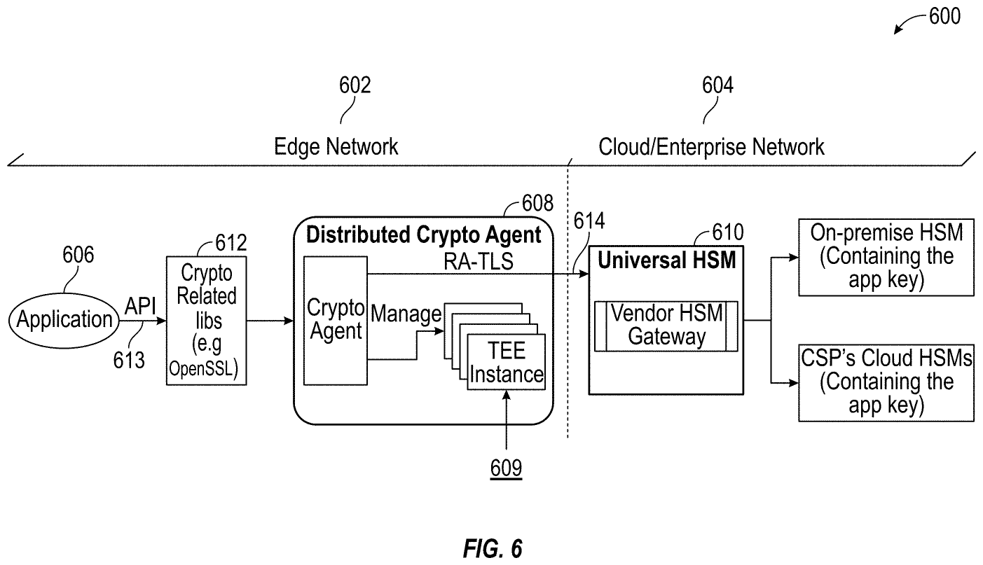

FIG. 6 illustrates signal and messaging flow 600 between components of a system according to some example embodiments. Some components of FIG. 6 can be similar to those discussed above with respect to FIG. 5. For example, similarly to FIG. 5, some elements of flow 600 can be executed with an edge network 602, which can be similar to e.g., edge cloud 110 (FIG. 1) or on-premises. Other components of the flow 600 can be executed within a cloud or enterprise network 604 similar to, e.g., cloud 130 (FIG. 1).

In some examples, before application 606 calls the cryptographic agent 608 to perform key operations, HSM agents can perform key operations within a key material bootstrap stage These key operations can include using a unified API provided by the universal HSM 610 to manage keys regardless of the CPS cloud-based HSM or vendor HSM. These operations can include key generation, key import, etc.

In a cryptographic agent 608 bootstrap stage, an application owner can choose a specific version of an image for the cryptographic agent 608 in advance, which has support for certain cryptographic algorithms, operations, etc. Applications 606 can also choose the implementation according to the footprint, wherein a footprint can be understood to include the size of the preferred agent. If the application 606 already has knowledge of the key materials that are going to be used, based on configuration data provided or data known to application developers or other users, the application 606 can trigger the key import in advance, to have the keys stored in a remote HSM cache (e.g., in memory of the relevant edge node 450 as described herein) to the cryptographic agent 608.

At runtime, an application 606 can request key related operations through cryptographic libraries 612 by providing flags or other indicators within API calls 613 to direct network traffic to the correct plugin. The cryptographic agent 608 can receive the request and determines whether the key needed for the operation exists in the local ephemeral TEE instance 609. If the key does not exist, cryptographic agent 608 can request the key from the remote Universal HSM 610 and configure a secure tunnel 614 (based on, e.g., Remote Attestation Transport Layer Security (RA-TLS) or other security apparatus or tunnel) to retrieve the key and related materials or objects securely. Otherwise, the cryptographic agent 608 can utilize the key already inside the ephemeral TEE instance 609, finish the key operations and return the result to the application.

Upon receiving requests from cryptographic agent 608, the universal HSM 610 can verify the cryptographic agent 608 identity and perform attestation to confirm that the agent is residing in a secure TEE environment. If the attestation passes, the universal HSM 610 can use the credential provided in the request to retrieve the keys in the relevant HSM (e.g., on-premises HSM 616, cloud based HSM 618, etc.) and return keys to the cryptographic agent 608, in some examples additionally wrapping the keys. In the context of embodiments, key wrapping can be understood to include a class of symmetric encryption algorithms designed to encapsulate (encrypt) cryptographic key material, which can protect keys in untrusted storage or help transmit keys over untrusted communications networks

Utilizing architecture 500 in conjunction with messaging flow 600 will help the operators streamline workflows and simplify key management and migration operations. Operators can continue to use HSMs and avoid networking overhead because some cryptographic operations can be performed locally. Crypto keys will be ephemeral on the edge side, and users can destroy ephemeral TEE instances to avoid access to or exploitation of keys. users can destroy the TEE instance to avoid further key exploitation.

### Methods According to Example Embodiments

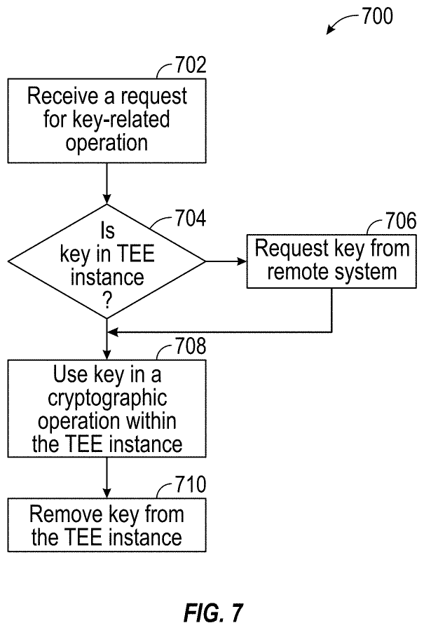

FIG. 7 is a flowchart of a method according to some example embodiments. The method can be performed by components of FIG. 5 and FIG. 6, for example the cryptographic agent 608 or other cryptographic components and processing circuitry.

The method 700 can begin with operation 702 with receiving a request for key-related operations. For example, the request can include a request to perform a cryptographic operation using a cryptographic key component. Cryptographic operations can include operations for accessing encoded data or services. In some example embodiments, the cryptographic agent 608 or other component can construct a TEE instance on the edge or within an on-premises component. The cryptographic key component can be stored within this TEE instance. In some examples, a security enclave can be provided within the TEE instance and the cryptographic key component can be stored in the security enclave.

If the cryptographic key component is already present or included within a TEE instance (e.g., TEE instances 609 (FIG. 6)) or security enclave as determined at operation 704, then the method can proceed with operation 708, described below, using the cryptographic key component within the TEE instance.

Otherwise, the cryptographic key component is requested from a remote system in operation 706 through, e.g., a universal HSM 610 as described earlier herein. For example, the method 700 can include transmitting a command to a remote component to retrieve the cryptographic key component. In some examples, at least one gateway process can be performed to obtain cryptographic key components, wherein the at least one gateway process provides an interface to at least one of a cloud-based key provider, a managed cloud key provider, and an on-premises key provider.

The method 700 can include operation 708, with using the cryptographic key component (whether obtained through a request described with reference to operation 706 or accessed from storage in the TEE or security enclave) to perform the cryptographic operation and provide a result of the cryptographic operation to the processing circuitry over the interface. After using the cryptographic key component, the method can proceed with removing the cryptographic key component from the TEE instance in operation 710. In some examples, the security enclave can also be removed, de-allocated, etc. subsequent to use of the cryptographic key component.

Operations 702 and 706 can be performed within an edge component or an on-premises component, with the requests being provided to components outside the edge component or the on-premises component. The method 700 can further include

Using any of the above methods and apparatuses in accordance with embodiments, users can achieve higher security assurance while meeting the constraints presented in edge/on-premise scenarios. Keys can be fetched for local storage at runtime for cryptographic operations rather than having such data traversing over a network, which can add to efficiency in systems according to various embodiments. Users are also provided with flexibility to operate with security apparatuses available through a variety of vendors and service providers.

### Other Systems and Components

The edge computing device 450 described above can include other components for performing operations in accordance with example embodiments. Referring again to FIG. 4, the edge computing device 450 may include processing circuitry in the form of a processor 452, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 452 may be a part of a system on a chip (SoC) in which the processor 452 and other components are formed into a single integrated circuit, or a single package, such as the Edison™ or Galileo™ SoC boards from Intel Corporation, Santa Clara, Calif. As an example, the processor 452 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 452 and accompanying circuitry may be provided in a single socket form factor, multiple socket form factor, or a variety of other formats, including in limited hardware configurations or configurations that include fewer than all elements shown in FIG. 4.

The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 456 may couple the processor 452 to a transceiver 466, for communications with the connected Edge devices 462. The transceiver 466 may use any number of frequencies and protocols. The wireless network transceiver 466 (or multiple transceivers) may communicate using multiple standards or radios for communications at a different range. For example, the Edge computing node 450 may communicate with close devices, e.g., within about 10 meters, using a local transceiver based on Bluetooth Low Energy (BLE), or another low power radio, to save power. More distant connected Edge devices 462, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 466 (e.g., a radio transceiver) may be included to communicate with devices or services in a cloud (e.g., an Edge cloud 495) via local or wide area network protocols. Given the variety of types of applicable communications from the device to another component or network, applicable communications circuitry used by the device may include or be embodied by any one or more of components 464, 466, 468, or 470. Accordingly, in various examples, applicable means for communicating (e.g., receiving, transmitting, etc.) may be embodied by such communications circuitry.

The Edge computing node 450 may include or be coupled to acceleration circuitry 464, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document.

In an example, the instructions 482 provided via the memory 454, the storage 458, or the processor 452 may be embodied as a non-transitory, machine-readable medium 460 including code to direct the processor 452 to perform electronic operations in the Edge computing node 450. The processor 452 may access the non-transitory, machine-readable medium 460 over the interconnect 456. For instance, the non-transitory, machine-readable medium 460 may be embodied by devices described for the storage 458 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 460 may include instructions to direct the processor 452 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

While the illustrated examples of FIG. 4 include example components for a compute node and a computing device, respectively, examples disclosed herein are not limited thereto. As used herein, a “computer” may include some or all of the example components of FIG. 4 in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIG. 4, each of which may include different sub-components, different memory capacities, I/O capabilities, etc. For example, because some implementations of distributed networking and/or distributed computing are associated with particular desired functionality, examples disclosed herein include different combinations of components illustrated in FIG. 4 to satisfy functional objectives of distributed computing tasks. In some examples, one or more objective functions of a distributed computing task(s) rely on one or more alternate devices/structure located in different parts of an Edge networking environment, such as devices to accommodate data storage.

Example 1 is an apparatus, comprising: interface coupled to processing circuitry; and cryptographic circuitry coupled to the interface and configured to: receive a request from the processing circuitry over the interface to perform a cryptographic operation using a remote hardware security module (HSM) key component; transmit a command to a remote component to retrieve the remote HSM key component; construct a trusted execution environment (TEE) instance; store the remote HSM key component in the TEE instance; and use the remote HSM key component to perform the cryptographic operation and provide a result of the cryptographic operation to the processing circuitry over the interface.

In Example 2, the subject matter of Example 1 can optionally include wherein the cryptographic circuitry operates within an edge component or an on-premises component, and wherein the command is provided to a remote component outside the edge component or the on-premises component.

In Example 3, the subject matter of Example 2 can optionally include wherein the cryptographic circuitry is configured to: construct the TEE instance on an edge device.

In Example 4, the subject matter of Example 3 can optionally include wherein the cryptographic circuitry is configured to allocate a security enclave within the TEE instance and to store the cryptographic key component in the security enclave.

In Example 5, the subject matter of Example 4 can optionally include wherein the cryptographic circuitry is configured to remove the security enclave and destroy the cryptographic key component subsequent to use of the cryptographic key component.

In Example 6, the subject matter of any of Examples 1-5 can optionally include hardware security circuitry configured to implement at least one gateway process to obtain cryptographic key components.

In Example 7, the subject matter of Example 6 can optionally include wherein the at least one gateway process provides an interface to at least one of a cloud-based key provider, a managed cloud key provider, and an on-premises key provider.

In Example 8, the subject matter of any of Examples 1-7 can optionally include a cache memory to store the cryptographic key component.

Example 9 is a computer-readable medium including instructions that, when executed on a device, cause the device to perform operations comprising: receiving a request to perform a cryptographic operation using a remote hardware security module (HSM) key component; transmitting a command to a remote component to retrieve the remote HSM key component; and subsequent to receiving the remote HSM key component, using the remote HSM key component to perform the cryptographic operation and provide a result of the cryptographic operation.

In Example 10, the subject matter of Example 9 can optionally include wherein the receiving and transmitting are performed within an edge component or an on-premises component, and wherein the command is provided to a remote component outside the edge component or the on-premises component.

In Example 11, the subject matter of Example 10 can optionally include wherein the operations further comprise: constructing the TEE instance on an edge device.

In Example 12, the subject matter of Example 11 can optionally include wherein the operations further comprise providing a security enclave within the TEE instance and to storing the cryptographic key component in the security enclave.

In Example 13, the subject matter of Example 12 can optionally include wherein the operations further comprise removing the security enclave and destroying the cryptographic key component subsequent to use of the cryptographic key component.

In Example 14, the subject matter of any of Examples 9-13 can optionally include wherein the operations further comprise implementing at least one gateway process to obtain cryptographic key components.

In Example 15, the subject matter of Example 14 can optionally include wherein the at least one gateway process provides an interface to at least one of a cloud-based key provider, a managed cloud key provider, and an on-premises key provider.

Example 16 is a method comprising: transmitting a command to a remote component to retrieve the remote HSM key component; transmitting a command to a remote component to retrieve the remote HSM key component; and subsequent to receiving the remote HSM key component, using the remote HSM key component to perform the cryptographic operation and provide a result of the cryptographic operation.

In Example 17, the subject matter of Example 16 can optionally include wherein the receiving and transmitting are performed within an edge component or an on-premises component, and wherein the command is provided to a remote component outside the edge component or the on-premises component.

In Example 18, the subject matter of Example 17 can optionally include constructing a trusted execution environment (TEE) instance on an edge device;

and storing the cryptographic key component in the TEE instance.

In Example 19, the subject matter of Example 18 can optionally include providing a security enclave within the TEE instance; and storing the cryptographic key component in the security enclave.

In Example 20, the subject matter of Example 19 can optionally include removing the security enclave and destroying the cryptographic key component subsequent to use of the cryptographic key component.

In Example 21, the subject matter of any of Examples 16-20 can optionally include implementing at least one gateway process to obtain cryptographic key components, wherein the at least one gateway process provides an interface to at least one of a cloud-based key provider, a managed cloud key provider, and an on-premises key provider.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus, comprising:
an interface coupled to processing circuitry; and
cryptographic circuitry coupled to the interface and configured to:
receive a request from the processing circuitry over the interface to perform a cryptographic operation using a remote hardware security module (HSM) key component;
transmit a command to a remote component to retrieve the remote HSM key component;
construct a trusted execution environment (TEE) instance;
store the remote HSM key component in the TEE instance; and
use the remote HSM key component to perform the cryptographic operation and provide a result of the cryptographic operation to the processing circuitry over the interface.

2. The apparatus of claim 1, wherein the cryptographic circuitry operates within an edge component or an on-premises component, and wherein the command is provided to a remote component outside the edge component or the on-premises component.

3. The apparatus of claim 2, wherein the cryptographic circuitry is configured to:
construct the TEE instance on an edge device.

4. The apparatus of claim 3, wherein the cryptographic circuitry is configured to allocate a security enclave within the TEE instance and to store the cryptographic key component in the security enclave.

5. The apparatus of claim 4, wherein the cryptographic circuitry is configured to remove the security enclave and destroy the cryptographic key component subsequent to use of the cryptographic key component.

6. The apparatus of claim 1, further comprising hardware security circuitry configured to implement at least one gateway process to obtain cryptographic key components.

7. The apparatus of claim 6, wherein the at least one gateway process provides an interface to at least one of a cloud-based key provider, a managed cloud key provider, and an on-premises key provider.

8. The apparatus of claim 1, further comprising a cache memory to store the cryptographic key component.

9. A computer-readable medium including instructions that, when executed on a device, cause the device to perform operations comprising:
receiving a request to perform a cryptographic operation using a remote hardware security module (HSM) key component;
transmitting a command to a remote component to retrieve the remote HSM key component; and
subsequent to receiving the remote HSM key component, using the remote HSM key component to perform the cryptographic operation and provide a result of the cryptographic operation.

10. The computer-readable medium of claim 9, wherein the receiving and transmitting are performed within an edge component or an on-premises component, and wherein the command is provided to a remote component outside the edge component or the on-premises component.

11. The computer-readable medium of claim 10, wherein the operations further comprise:
constructing a trusted execution environment (TEE) instance on an edge device; and
storing the remote HSM key component in the TEE instance.

12. The computer-readable medium of claim 11, wherein the operations further comprise providing a security enclave within the TEE instance and to storing the cryptographic key component in the security enclave.

13. The computer-readable medium of claim 12, wherein the operations further comprise removing the security enclave and destroying the cryptographic key component subsequent to use of the cryptographic key component.

14. The computer-readable medium of claim 9, wherein the operations further comprise implementing at least one gateway process to obtain cryptographic key components.

15. The computer-readable medium of claim 14, wherein the at least one gateway process provides an interface to at least one of a cloud-based key provider, a managed cloud key provider, and an on-premises key provider.

16. A method comprising:
receiving a request to perform a cryptographic operation using a remote hardware security module (HSM) key component;
transmitting a command to a remote component to retrieve the remote HSM key component; and
subsequent to receiving the remote HSM key component, using the remote HSM key component to perform the cryptographic operation and provide a result of the cryptographic operation.

17. The method of claim 16, wherein the receiving and transmitting are performed within an edge component or an on-premises component, and wherein the command is provided to a remote component outside the edge component or the on-premises component.

18. The method of claim 17, further comprising:
constructing a trusted execution environment (TEE) instance on an edge device; and
storing the remote HSM key component in the TEE instance.

19. The method of claim 18, further comprising:
providing a security enclave within the TEE instance; and
storing the cryptographic key component in the security enclave.

20. The method of claim 19, further comprising removing the security enclave and destroying the cryptographic key component subsequent to use of the cryptographic key component.

21. The method of claim 16, further comprising implementing at least one gateway process to obtain cryptographic key components, wherein the at least one gateway process provides an interface to at least one of a cloud-based key provider, a managed cloud key provider, and an on-premises key provider.
